(19) United States
(12) Patent Application Publication
(10) Pub. No.: US 2016/0258208 A1
(43) Pub. Date: Sep. 8, 2016

(54) Rain Shield for Single and Double Hung Windows

(71) Applicant: Bobby R. Soha, Brooklyn, OH (US)

(72) Inventor: Bobby R. Soha, Brooklyn, OH (US)

(21) Appl. No.: 14/641,165

(22) Filed: Mar. 6, 2015

(51) Int. Cl. E06B 7/14; E04B 1/64

(52) U.S. Cl. CPC E06B 7/14; E04B 1/64

(57) ABSTRACT

A water prevention device which can be installed into any window size opening.

The unit is easily installed on the inside and once situated atop of the window sill it slides open and hugs the sides of the window frame tightly. The arms are then folded outward and the unit is angled inward. Once the window is rested atop of the arms rain or other water sources cannot enter and fresh air is allowed to flow in and out unimpeded.

### BACKGROUND

The Invention relates in general to a Rain Shield that could be Installed with existing Single or Double Hung Windows in any structure, or as an addition to pre-hung or pre-fab Windows.

When a window is left open for any reason and rain occurs, the water from said rain may enter the building creating a moisture problem soaking the window sill and or the ledge, as well as leaking into and in between the walls and damaging drywall including the floor or other like building materials, Thusly causing costly replacements to damaged areas.

This Invention will keep the rain or water from entering said windows therefore eliminating any water damage and or costly repairs while at the same time allowing fresh air to enter the structure.

### SUMMARY

The present Invention relates to a water damage prevention device that is comprised of plastic or a like substance that is measured to fit most installed or pre-fabricated windows horizontally, whereas one piece maintains two one hundred and eighty degree folds, top and bottom respectfully that serve as a guide for the second piece to slide into therefore being able to retro-fit said invention tightly into the window tract opening upon the window sill from inside, utilizing the guide to slide open or closed as the width deems necessary for a tight fit. Additionally, affixed to either end are flexible hinges to which side arms are attached. The side arms being at an approximate 30 degree angle are then folded ninety degrees outward which are utilized as a brace for the lower window to rest upon that leaves an inward tilted opening to which fresh air can circulate through. Water therefore cannot pass through this barrier.

### BRIEF DESCRIPTION OF THE DRAWINGS

FIG. 1 is a Complete View of the Present Invention

FIG. 2 is a Side View

FIG. 3 is a Side View

### DETAILED DESCRIPTION OF THE DRAWINGS

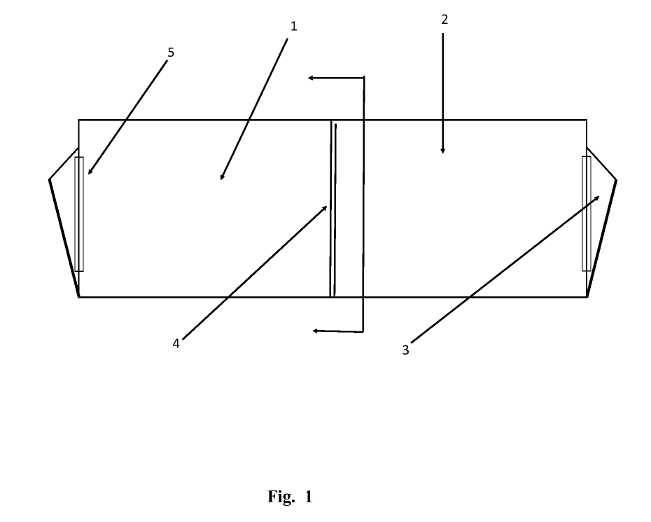

Referring now to FIG. 1, a Complete View of the present invention:

(1) and (2) are two pieces of Plastic Panels or like substance with (4) showing the separation of (1) and (2). The directional lines showing that (2) can slide either in front of or behind (1). Affixed to (1) and (2) with PVC flexible tape or like product (5) are angled side arms (3).

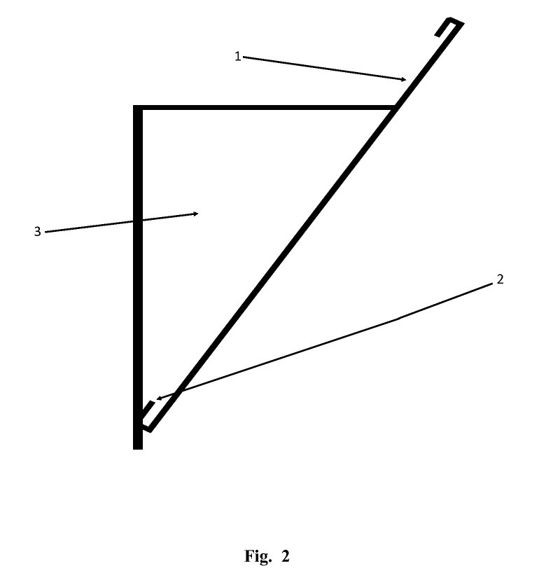

In FIG. 2 shown is a Side View of the present invention. Shown in this embodiment is the clear plastic panel or other like material (1), to which an outer single hem joint has been fabricated (2). Additionally, affixed to (1) the clear plastic panel, is the side arm (3), with clear PVC flexible tape or like product (not shown).

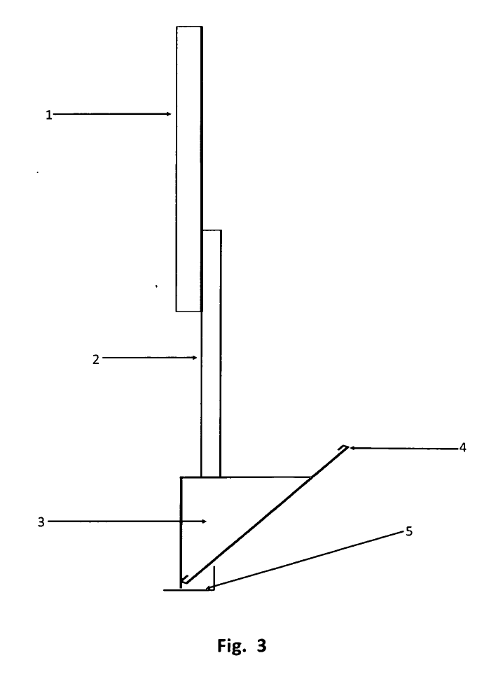

Referring now to FIG. 3, a Side View of the current invention: (1) and (2) is a double hung window, (1) being the top window and (2) the bottom window. As shown, the bottom window (2) rests upon one of the side arms (3). The side arms (3) are attached a clear plastic or other like material (4) to which a single hem joint has been fabricated on the top and bottom respectfully. (5) shows the widow sill to which the invention sits.

1. A window installed water prevention device which is easily installed whilst inside to deter water from outside sources entering comprising;
two separate panes of PVC or like material of similar sized panels to which the primary one is heat fabricated horizontally on the top and bottom periphery to incur a single hem joint to which the secondary panel would be incorporated therefore creating a moveable slide action to which two arms are affixed comprising;
two panels which are angled with the butt of said angles maintaining a ninety degree tab to be used as a stop against the sash of the window, to such a degree that when attached with a flexible PVC heat induced adherent one unit is therefore generated which would rest on the sill of said window therefore utilizing the slide to expand the unit to retrofit into the opening horizontally thence the bottom window would rest atop of said tabs which would inherently angle inward creating an atmosphere that would deter water from entering and maintaining air flow.
